(19) United States
(12) Patent Application Publication
(10) Pub. No.: US 2023/0072230 A1
(43) Pub. Date: Mar. 9, 2023

(54) SYSTEM AMD METHOD FOR SCENE BASED POSITIONING AND LINKING OF VEHICLES FOR ON-DEMAND AUTONOMY

(71) Applicant: GM GLOBAL TECHNOLOGY OPERATIONS LLC, Detroit, MI (US)

(72) Inventors: Prakash Mohan Peranandam, Rochester Hills, MI (US); Arun Adiththan, Sterling Heights, MI (US); Ramesh Sethu, Troy, MI (US); Joseph G. D Ambrosio, Clarkston, MI (US)

(73) Assignee: GM GLOBAL TECHNOLOGY OPERATIONS LLC, Detroit, MI (US)

(21) Appl. No.: 17/447,108

(22) Filed: Sep. 8, 2021

(51) Int. Cl. G08G 1/00; B60W 40/12; G07C 5/00; G06N 20/00

(52) U.S. Cl. CPC G08G 1/22; B60W 40/12; G07C 5/008; G06N 20/00

(57) ABSTRACT

Methods and systems for an On-Demand Autonomy (ODA) system are provided. A method includes: receiving a request for ODA service from the Fv, wherein the request includes a location of the Fv; when the Lv is within a first distance of the location of the Fv: identifying the Fv within a scene of an environment of the Lv; identifying an orientation of the Fv within the scene of the environment of the Lv; and determining a second location for the Lv to begin the ODA service; when the Lv is within a second distance of the second location, determining a closeness of other vehicles within a second scene of the environment of the Lv; confirming the orientation of the Fv in the second scene; performing a handshake method with the Fv to create a virtual link between the Lv and the Fv; and performing at least one of pulling and parking platooning methods using the created virtual link.

### TECHNICAL FIELD

The technology described in this patent document relates generally to an On-Demand Autonomy (ODA) service for semi-autonomous/autonomous vehicles/pods and more particularly to positioning and linking of entities in an ODA service.

An autonomous vehicle is a vehicle that can sense its environment and navigating with little or no user input. An autonomous vehicle senses its environment using sensing devices such as radar, lidar, image sensors, and the like. The autonomous vehicle system further uses information from a positioning system including global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels. There may be situations where a vehicle could benefit from autonomous driving capabilities but is not equipped with all the necessary components to allow for fully autonomous driving experience.

An On-Demand Service provides on-demand mobility to users by providing transportation through a fleet of vehicles that include at least one autonomous vehicle that is capable of leading non-autonomous or semi-autonomous vehicles. In order for the autonomous vehicle to lead the non-autonomous vehicle, the vehicles must be “linked” in communication.

Accordingly, it is desirable to provide systems and methods for an On-Demand Autonomy (ODA) service that enables the vehicles to position themselves such that they can be linked. Furthermore, other desirable features and characteristics will become apparent from the subsequent detailed description and the appended claims, taken in conjunction with the accompanying drawings.

### SUMMARY

Systems and methods for an On-Demand Autonomy (ODA) service are provided. In one embodiment, an On-Demand Autonomy (ODA) system including a follower vehicle (Fv), a leader vehicle (Lv), and the ODAS is provided. The ODAS includes a controller for supporting platooning after platoon trip initiation. The controller includes non-transitory computer readable media and one or more processors configured by programming instructions on the non-transitory computer readable media to: receive a request for ODA service from the Fv, wherein the request includes a location of the Fv; when the Lv is within a first distance of the location of the Fv: identify the Fv within a scene of an environment of the Lv; identify an orientation of the Fv within the scene of the environment of the Lv; and determine a second location for the Lv to begin the ODA service. When the Lv is within a second distance of the second location, determine a closeness of other vehicles within a second scene of the environment of the Lv; confirm the orientation of the Fv in the second scene; perform a handshake method with the Fv to create a virtual link between the Lv and the Fv; and perform at least one of pulling and parking platooning methods using the created virtual link.

In various embodiments, the controller is further configured to determine the scene of the environment based on sensor data generated from sensors of the Lv.

In various embodiments, the controller is configured to identify the Fv based on a machine learning model and parameters associated with the Fv.

In various embodiments, the controller is configured to identify the orientation of the Fv based on a second machine learning model and map data indicating a type of parking.

In various embodiments, the controller is configured to determine the second location based on at least one of a machine learning model and a Partially Observable Markov Decision Process model and map data, and traffic data.

In various embodiments, the controller is configured to confirm the orientation of the Fv in the second scene based on a second machine learning model and parameters of the Fv.

In various embodiments, the handshake method establishes a secure communication link between the Lv and the Fv.

In various embodiments, the handshake method confirms control function of the Fv based on communications from the Lv.

In various embodiments, the handshake method confirms the control functions based on a machine learning model that analyzes a scene of the Lv.

In various embodiments, the controller is further configured to control a notification device of at least one of the Lv and the Fv to indicate the ODA service.

In another embodiment, a method in an On-Demand Autonomy (ODA) system comprising a follower vehicle (Fv), a leader vehicle (Lv), and an ODAS is provided. The method includes: receiving a request for ODA service from the Fv, wherein the request includes a location of the Fv; when the Lv is within a first distance of the location of the Fv: identifying the Fv within a scene of an environment of the Lv; identifying an orientation of the Fv within the scene of the environment of the Lv; and determining a second location for the Lv to begin the ODA service; when the Lv is within a second distance of the second location, determining a closeness of other vehicles within a second scene of the environment of the Lv; confirming the orientation of the Fv in the second scene; performing a handshake method with the Fv to create a virtual link between the Lv and the Fv; and performing at least one of pulling and parking platooning methods using the created virtual link.

In various embodiments, the determining the scene of the environment is based on sensor data generated from sensors of the Lv.

In various embodiments, identifying the Fv is based on a machine learning model and parameters associated with the Fv.

In various embodiments, the identifying the orientation of the Fv is based on a second machine learning model and map data indicating a type of parking.

In various embodiments, the determining the second location is based on at least one of a machine learning model and a Partially Observable Markov Decision Process model and map data, and traffic data.

In various embodiments, the confirming the orientation of the Fv in the second scene is based on a second machine learning model and parameters of the Fv.

In various embodiments, the handshake method establishes a secure communication link between the Lv and the Fv.

In various embodiments, the handshake method confirms control function of the Fv based on communications from the Lv.

In various embodiments, the handshake method confirms the control functions based on a machine learning model that analyzes a scene of the Lv.

In various embodiments, the method includes controlling a notification device of at least one of the Lv and the Fv to indicate the ODA service.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram illustrating an example On-Demand Autonomy (ODA) system for providing ODA services, in accordance with various embodiments;

FIG. 2 is a block diagram illustrating an example vehicle that may be used in the example ODA system as a leader vehicle or a follower vehicle, in accordance with various embodiments;

FIG. 3 is a sequence diagram illustrating interactions and timing between an ODA server, a leader vehicle, and a follower vehicle resulting from a request for ODA services from the follower vehicle, in accordance with various embodiments;

FIG. 4 is a flowchart illustrating a method for positioning and linking performed by the leader vehicle in response to the request for ODA services from the follower vehicle, in accordance with various embodiments;

FIG. 5 is an illustration of an identified follower vehicle within an exemplary scene as determined by the leader vehicle, in accordance with various embodiments;

FIG. 6 is illustration of parking types and vehicle orientations that are determined when positioning and linking by the leader vehicle, in accordance with various embodiments; and

FIG. 7 is a flowchart illustrating a method for positioning and de-linking performed by the leader vehicle in response to the completion of ODA services, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for an On-Demand Autonomy (ODA) system that enables positioning and linking/de-linking a leader vehicle and a follower vehicle in response to an ODA service request by the follower vehicle. They ODA system enables the leader vehicle to position itself in a safe situation to initiate the On-Demand Autonomy ride service. Determination of such an optimal position is dynamic and based on the scene understanding and the situation of the partner vehicle. Once positioned, a handshake protocol is executed, and cross referenced with camera/sensor based monitoring and once all clear the On-Demand Autonomy ride service shall be performed by informing a controlling server. At the end of the ride, safe position is again determined to park the follower in a safe and secured area before de-linking.

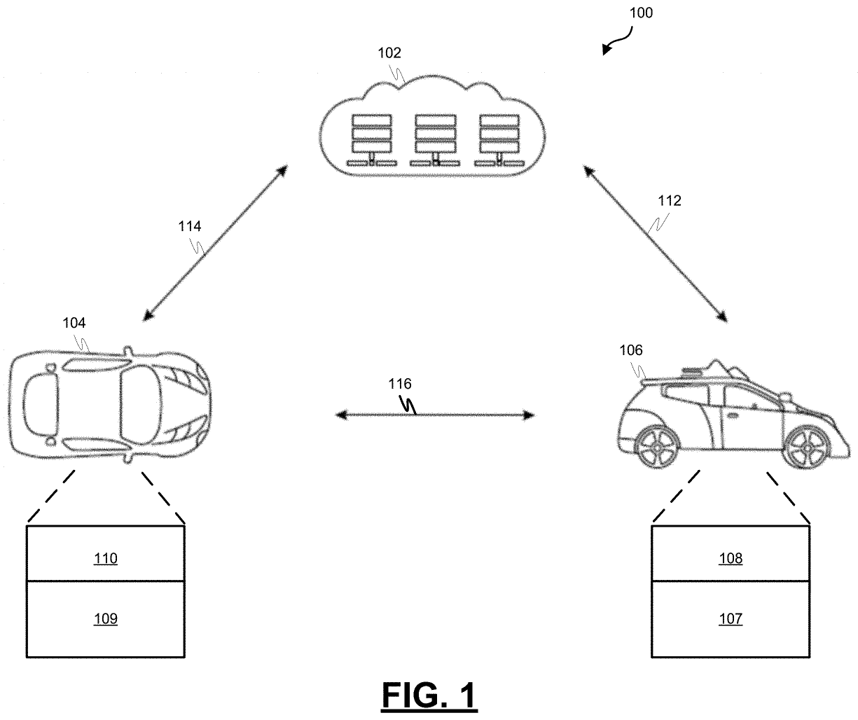

With reference now to FIG. 1, a functional block diagram illustrates an example On-Demand Autonomy (ODA) system 100 in accordance with various embodiments. In various embodiments, the ODA system 100 includes an On-Demand Autonomy server (ODAS) 102, one or more follower vehicles (Fv) 104, and one or more leader vehicles (Lv) 106. In general, the on-demand autonomy (ODA) system 100 enables an on-demand autonomy (ODA) service with programmed modules and communications systems that enable one or more vehicles to be driven in a platoon.

For example, the ODA service allows for autonomous equipped vehicles (i.e., the leader vehicle 106) to extend their autonomous driving capabilities to other non-autonomous vehicles (i.e., the follower vehicle 104) upon request. In other words, the autonomous leader vehicle 106 is configured with at least one controller 107 that includes a leader module 108 that controls the leader vehicle 106 to lead the non-autonomous follower vehicle 104 with little attention from the driver of the non-autonomous vehicle 104 from point A to point B as directed by the ODAS 102. The non-autonomous follower vehicle 104 is configured with at least once controller 109 that includes a follower module 110 that controls the follower vehicle 104 to follow the autonomous leader vehicle 106 and to relinquish driving control to the autonomous leader vehicle 106 for the trip from point A to point B as directed by the ODAS 102.

In various embodiments, the Lv 106 is communicatively coupled to the ODAS 102 via a communication link 112, and the Fv 104 is communicatively coupled to the ODAS 102 via a communication link 114. Through the communication links 112, 114, the ODAS 102 can facilitate setup of a platooning trip between the Lv 106 and the Fv 104, monitor the Lv 106 and the Fv 104 during the platooning trip, communicate status information regarding the platooned vehicles 104, 106 to each other, communicate platoon termination requests between the platooned vehicles 104, 106, communicate safety information between the platooned vehicles 104, 106, as well as other tasks to enable an effective ODA service.

In various embodiments, the Lv 106 is dynamically coupled to the Fv 104 via a virtual link 116. The virtual link 116 is established when a need for platooning has been identified and the Fv 104 is in proximity to the Lv 106 as will be discussed in more detail below.

In various embodiments, the virtual link 116 and the communication links 112, 114, may be implemented using a wireless carrier system such as a cellular telephone system and/or a satellite communication system. The wireless carrier system can implement any suitable communications technology, including, for example, digital technologies such as CDMA (e.g., CDMA2000), LTE (e.g., 4G LTE or 5G LTE), GSM/GPRS, or other current or emerging wireless technologies.

The communication links 112, 114, may also be implemented using a conventional land-based telecommunications network coupled to the wireless carrier system. For example, the land communication system may include a public switched telephone network (PSTN) such as that used to provide hardwired telephony, packet-switched data communications, and the Internet infrastructure. One or more segments of the land communication system can be implemented using a standard wired network, a fiber or other optical network, a cable network, power lines, other wireless networks such as wireless local area networks (WLANs), or networks providing broadband wireless access (BWA), or any combination thereof.

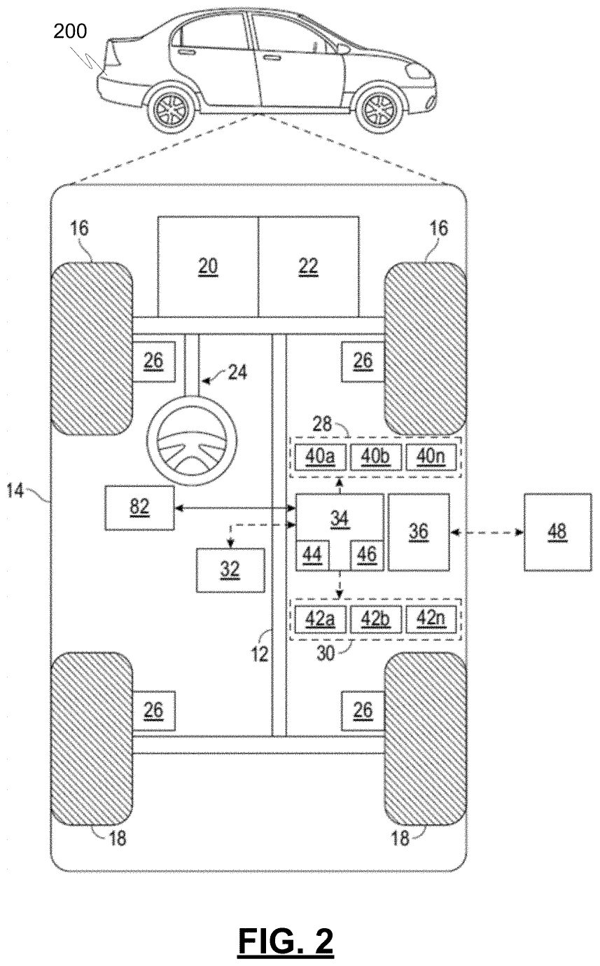

Referring now to FIG. 2, a block diagram illustrates an example vehicle 200 that may be used in the example ODA system 100 as either a Lv 106 or a Fv 104. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14. The vehicle 200 is depicted in the illustrated embodiment as a passenger car, but other vehicle types, including trucks, sport utility vehicles (SUVs), recreational vehicles (RVs), etc., may also be used.

The vehicle 200 may be capable of being driven manually, autonomously, and/or semi-autonomously. For example, the vehicle 200 may be configured as the Fv 104 with a Level Two plus autonomous capability or may be configured as the Lv 106 with a Level Four, or Five autonomous capability. A Level Two or Two Plus system indicates “semi-automation” features that enable the vehicle to receive instructions and/or determine instructions for controlling the vehicle without driver intervention. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In various embodiments, the vehicle 200 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, a communication system 36 that is configured to wirelessly communicate information to and from other entities 48, such as the other vehicle (Lv 106 or Fv 104) and the ODAS 102, and a notification device 82 that generates visual, audio, and/or haptic notifications to users in proximity to the vehicle 200.

The sensor system 28 includes one or more sensing devices 40a-40n that sense observable conditions of the exterior environment and/or the interior environment of the autonomous vehicle 10. The sensing devices 40a-40n can include, depending on the level of autonomy of the vehicle 200, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26.

The communication system 36 is configured to wirelessly communicate information to and from the other entities 48, such as but not limited to, other vehicles (“V2V” communication) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the vehicle 200. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 2, embodiments of the vehicle 200 may include any number of controllers 34 that communicate over any suitable communication medium or a combination of communication mediums and that cooperate to process the sensor signals, perform logic, calculations, methods, and/or algorithms, and generate control signals to automatically control features of the vehicle 200.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34.

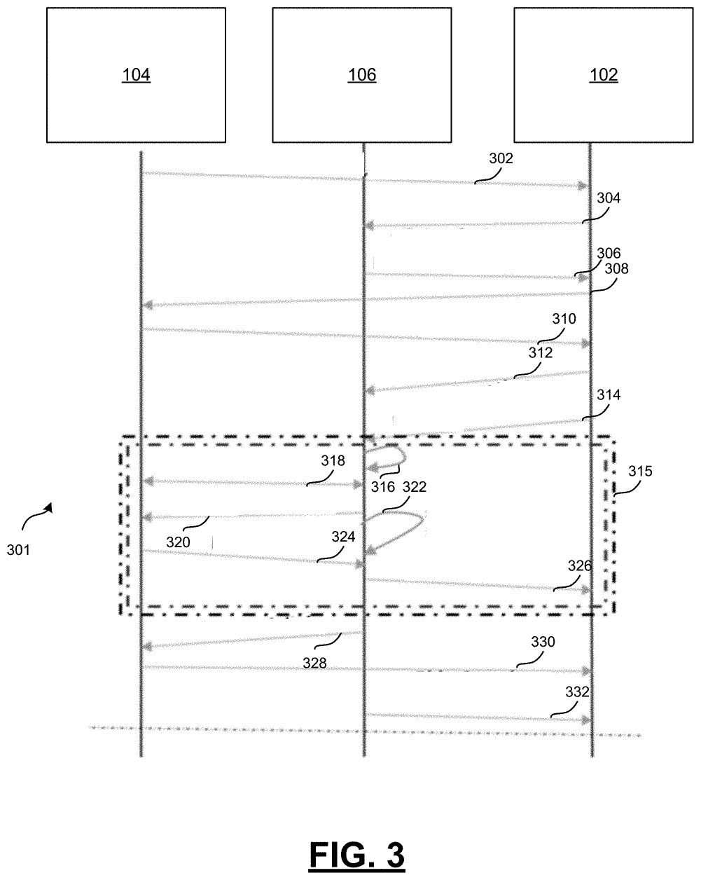

The programming instructions may include one or more separate programs, each of which comprises an ordered listing of executable instructions for implementing logical functions. In various embodiments, the instructions may be implemented in the leader module 108 (FIG. 1) or the follower module 110 (FIG. 1). The instructions, when executed by the processor, perform positioning and linking the vehicles 104, 106 as will be discussed in more detail with regard to FIGS. 3-6.

With reference to FIG. 3, a sequence diagram illustrates example interactions over time 301 between the ODA server 102, the Fv 104, and the Lv 106 resulting from a request for a platooning trip. In this example, the ODA service request is communicated by the Fv 104 to the ODAS 102 at 302. The ODAS 102, in response, broadcasts a message indicating the request to potential leader vehicles including Lv 106 in the area at 304. The Lv 106 receives the broadcast message and responds to the ODAS 102 with acceptance of the request at 306. The ODAS 102 communicates the leader information to the requesting Fv 104 at 308. The Fv 104 receives the leader information and responds to the ODAS 102 with an acknowledgment at 310. The ODAS 102 then responds to the Lv 106 with a confirmation of the leadership at 312. The ODAS 102 then provides to the Lv 106 location information of the Fv 104 and location information of a requested destination at 314.

Thereafter, the Lv 106 performs the positioning and linking of the Lv 106 and the Fv 104 at the operations of 315. For example, the Lv 106 performs identification of the Fv 104 and positions itself relative to the Fv 104 in order to establish the virtual link 116 (FIG. 1) at 316. Once positioned, the Lv 106 and the Fv 104 perform a communication handshake at 318 and the platoon request is communicated by the Lv 106 to the Fv 104 at 320.

Smart platoon indication is performed by the Lv 106 at 322. The Fv 104, in response, communicates the platoon virtual link information to the Lv 106 at 324. The Lv 106 communicates a ride confirmation to the ODAS 102 at 326. Thereafter, the platooning is performed based on the established virtual link 116 (FIG. 1) at 328. Once the ride is complete, the virtual link 116 (FIG. 1) is delinked at 330 and the Fv 104 and the Lv 106 send confirmation to the ODAS 102 that the ride is complete at 332.

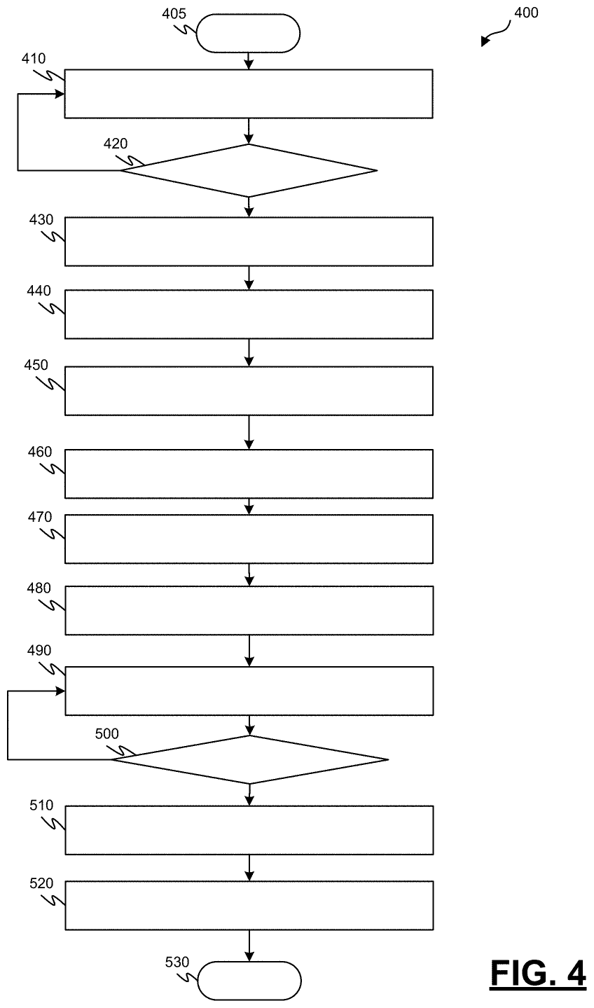

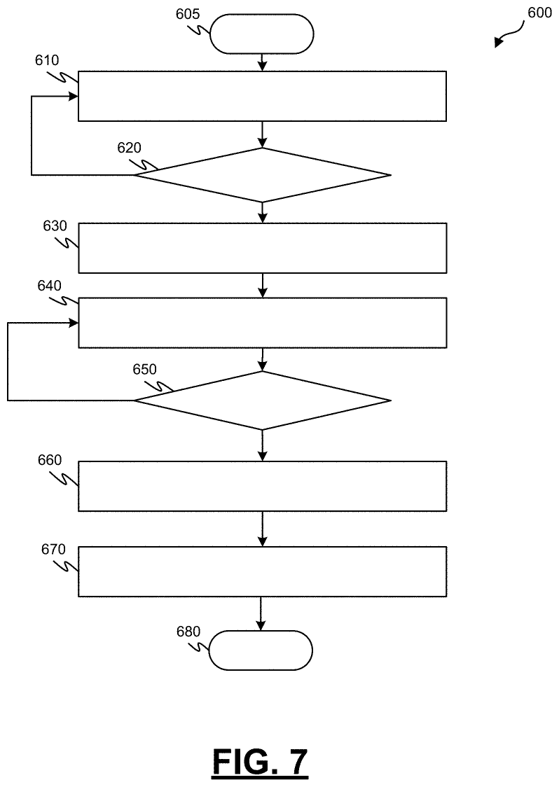

Referring now to FIGS. 4 and 7 and with continued reference to FIGS. 1-3, flowcharts illustrate control methods 400, 600 that can be performed by system 100 of FIG. 1, and more particularly by the leader module 108 of the Lv 106 in accordance with the present disclosure. As can be appreciated in light of the disclosure, the order of operation within the control methods 400, 600 is not limited to the sequential execution as illustrated in FIG. 4 but may be performed in one or more varying orders as applicable and in accordance with the present disclosure. In various embodiments, the methods 400, 600 can be scheduled to run based on one or more predetermined events, and/or can run continuously during operation of the Lv 106. For example, the methods 400, 600 may be performed based on the sequence of operations of FIG. 3.

In one example, the method may begin at 405. The location of the Fv 104 is received at 410, for example, from the ODAS 102 or in response to a crowdsourced leader search request-acknowledgement process. The Lv 106 is controlled based on the location until it is determined to be within a close distance (e.g., fifty meters based on map and/or GPS data) of the Fv 104 at 420.

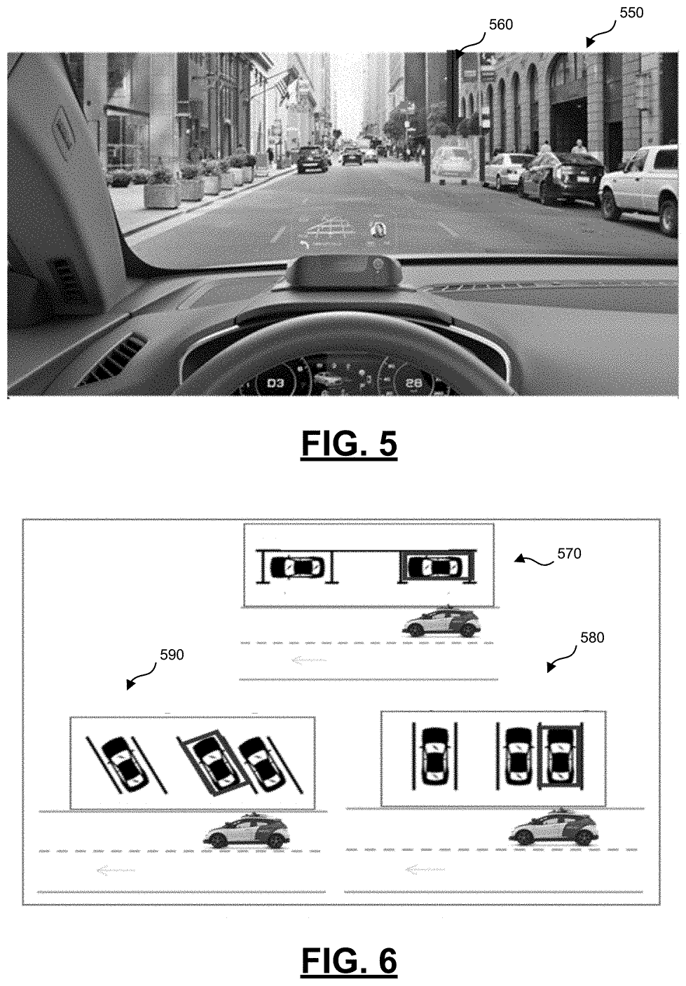

Thereafter, identification of the Fv 104 within the local environment is performed at 430. In various embodiments, a scene is generated based on sensor data from the sensor system 28 of the Lv 106; and the scene is analyzed based on one or more trained machine learning models to identify one or more parameters of the Fv 104 in a vehicle present in a scene. For example, as shown in FIG. 5, an identified vehicle 560 of the scene 550 may be visually analyzed for recognition of a make, model, color, registration number or other profile information associated with the Fv 104. In another example, an identified vehicle 560 of the scene 550 may be acoustically analyzed based on a pattern honking, pattern engine revving, or other sound pattern that may be generated by the Fv 104 to identify itself to the Lv 106.

In various embodiments, the Fv 104 may be additionally or alternatively identified based on an analysis of a short range signal from the Fv 104 such as a Wi-Fi/Bluetooth signal or encoded infrared signal analysis. As the Lv 106 becomes closer to the Fv 104, it is expected that the Bluetooth signal becomes stronger. As can be appreciated, other methods can be used to identify the Fv 104 within the local environment as the disclosure is not limited to any one of the present examples.

With reference back to FIG. 3, once the Fv 104 has been identified at 430, an orientation of the identified Fv 104 is determined at 440. In various embodiments, the orientation is identified based on one or more scene analysis models that analyze the identified vehicle for orientation relative to an identified parking space at the location of the identified vehicle. In various embodiments, the analysis and the thus, the model used is based on the parking type of the parking space (e.g., parallel parking, angle parking, perpendicular parking, etc.) that is associated with the identified location (e.g., based on map data). For example, as shown in FIG. 6, when the parking type is parallel parking at 570, the orientation is of the vehicle is expected to correspond to the road direction. The identified vehicle is visually analyzed to confirm that the front of the identified vehicle is heading in the road direction. In another example, when the parking type is angle parking at 590, the orientation of the vehicle is expected to correspond to the space direction. The identified vehicle is visually analyzed to confirm whether the front or the back of the identified vehicle is heading in the space direction. In still another example, when the parking type is perpendicular parking 580, the orientation of the vehicle is expected to correspond to the space direction. The identified vehicle is visually analyzed to confirm whether the front or the back of the identified vehicle is heading in the space direction.

In various embodiments, the Fv 104 may moving (and not parked). In such case, the orientation is identified based on one or more scene analysis models that analyze the identified vehicle for orientation relative to a lane associated with the location of the identified vehicle. In various embodiments, the analysis and thus, the model used is based on a lane type and/or direction of the lane and/or number of lanes and the traffic situation.

With reference back to FIG. 4, thereafter, the orientation of the Fv 104 and the surrounding scene are analyzed using a machine learning model to determine a position for the Lv 106 to move to in order to initiate the platooning (e.g., parked next to on a side road, roadside parking with no space in front, etc.) at 450. In various embodiments, a lane or available parking space closest to the identified vehicle is determined based on the identified vehicle's orientation, map data, and traffic data. For example, if the traffic data indicates that traffic on the roadway is heavy, a closest available parking space is searched for from the scene. In various other embodiments, when the Fv 104 is moving, it is determined whether the vehicle is operated manually by a driver or another leader vehicle. Thereafter, a position within the lane of the identified vehicle or a lane closest to the identified vehicle is determined based on how the vehicle is being driven, the identified vehicle's orientation, map data, and traffic data. The determination can be made, for example, by a Partially Observable Markov Decision Process (POMDP) model considering a defined set of parameter inputs.

Once the platoon initiation position is determined at 450, the Lv 106 is controlled to the position at 460. The notification device 82 of the Lv 106 is also controlled, for example, once the Lv 106 is in close proximity to the Fv 104. In various embodiments, the Lv 106 is controlled to a stop at or near the position and where the vehicles 104, 106 each have clear vision of each other. In various embodiments, the situation based decisions can be provided by a POMDP model considering a defined set of parameter inputs.

Once the Lv 106 is stopped, an analysis is performed of the environment to determine closeness to other vehicles and to re-determine the orientation of the identified vehicle for establishing a pull angle at 480. The handshake is performed at 490. In various embodiments, a secure V2V connection is established, and control functions are verified. For example, brake function, steering function, turn indicator function, and engine crank function are confirmed visually by the Lv 106 and/or directly by the Fv 104.

Before platooning begins, the notification device 82 of the Lv 106 and/or the Fv 104 is controlled to indicate the On-Demand Autonomy ride is about to begin to other road users (e.g., such as a flickering light or other notification means). Once the platooning is ready to begin at 500, the platooning is performed to autonomously control the operation of the Fv 104 from the position to the final destination using advance platooning methods at 510. If any pick-up or drop-off interrupt events were indicated by the request, the platooning is performed based thereon. Once the destination has been reached, position of the Fv 104 and de-linking of the virtual link 116 is performed at 520. Thereafter, the method may end at 530.

FIG. 7, illustrates a method 600 for de-linking the Fv 104 once the destination has been reached or is about to be reached as described at step 520 of FIG. 4. In one example, the method may begin at 605. A parking option search is initiated at 610. In various embodiments, a scene analysis is performed using a machine learning/POMDP model to identify a parking location that is available for the Lv 104 to be parked.

Once the parking location is identified at 620, the parking location type is determined and a parking method that corresponds to the parking location type is selected at 630. The Fv 104 is parked based on the selected parking method at 640. In the case of a parking request within a private garage, then Fv 104 uses the Lv 106 garage opening options or communicates with the service requester via ODAS 102 for garage access to securely park the Fv 104.

Once it is confirmed that the Fv 104 is parked at its destination at 650, the Lv 106 performs de-linking of the virtual link 116 at 660. The Lv 106 then is controlled to a waiting location to wait for a next request at 670. Thereafter, the method may end at 680.

One or more of the models used in evaluating the environment of the Lv 106 may be implemented as one or more machine learning models that undergo supervised, unsupervised, semi-supervised, or reinforcement learning. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In various embodiments, training of any of the models is performed by the leader module. In other embodiments, training occurs at least in part within the controller 34 of vehicle 10, itself. In various embodiments, training may take place within a system remote from Lv 106 and subsequently downloaded to Lv 106 for use during normal operation of Lv 106.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An On-Demand Autonomy (ODA) system comprising a follower vehicle (Fv), a leader vehicle (Lv), and an ODA server, the leader vehicle comprising a controller for supporting platooning after platoon trip initiation, the controller comprising non-transitory computer readable media and one or more processors configured by programming instructions on the non-transitory computer readable media to:
receive a request for ODA service from the Fv, wherein the request includes a location of the Fv;
when the Lv is within a first distance of the location of the Fv:
identify the Fv within a scene of an environment of the Lv;
identify an orientation of the Fv within the scene of the environment of the Lv; and
determine a second location for the Lv to begin the ODA service;
when the Lv is within a second distance of the second location,
determine a closeness of other vehicles within a second scene of the environment of the Lv;
confirm the orientation of the Fv in the second scene;
perform a handshake method with the Fv to create a virtual link between the Lv and the Fv; and
perform at least one of pulling and parking platooning methods using the created virtual link.

2. The system claim 1, wherein the controller is further configured to determine the scene of the environment based on sensor data generated from sensors of the Lv.

3. The system of claim 1, wherein the controller is configured to identify the Fv based on a machine learning model and parameters associated with the Fv.

4. The system or claim 3, wherein the controller is configured to identify the orientation of the Fv based on a second machine learning model and map data indicating a type of parking.

5. The system of claim 1, wherein the controller is configured to determine the second location based on at least one of a machine learning model and a Partially Observable Markov Decision Process model and map data, and traffic data.

6. The system of claim 4, wherein the controller is configured to confirm the orientation of the Fv in the second scene based on a second machine learning model and parameters of the Fv.

7. The system of claim 1, wherein the handshake method establishes a secure communication link between the Lv and the Fv.

8. The system of claim 7, wherein the handshake method confirms control function of the Fv based on communications from the Lv.

9. The system of claim 8, wherein the handshake method confirms the control functions based on a machine learning model that analyzes a scene of the Lv.

10. The system of claim 1, wherein the controller is further configured to control a notification device of at least one of the Lv and the Fv to indicate the ODA service.

11. A method in an On-Demand Autonomy (ODA) system comprising a follower vehicle (Fv), a leader vehicle (Lv), and an ODAS, the method comprising:
receiving a request for ODA service from the Fv, wherein the request includes a location of the Fv;
when the Lv is within a first distance of the location of the Fv:
identifying the Fv within a scene of an environment of the Lv;
identifying an orientation of the Fv within the scene of the environment of the Lv; and
determining a second location for the Lv to begin the ODA service;
when the Lv is within a second distance of the second location,
determining a closeness of other vehicles within a second scene of the environment of the Lv;
confirming the orientation of the Fv in the second scene;
performing a handshake method with the Fv to create a virtual link between the Lv and the Fv; and
performing at least one of pulling and parking platooning methods using the created virtual link.

12. The method of claim 11, wherein the determining the scene of the environment is based on sensor data generated from sensors of the Lv.

13. The method of claim 11, wherein identifying the Fv is based on a machine learning model and parameters associated with the Fv.

14. The method of claim 13, wherein the identifying the orientation of the Fv is based on a second machine learning model and map data indicating a type of parking.

15. The method of claim 11, wherein the determining the second location is based on at least one of a machine learning model and a Partially Observable Markov Decision Process model and map data, and traffic data.

16. The method of claim 14, wherein confirming the orientation of the Fv in the second scene is based on a second machine learning model and parameters of the Fv.

17. The method of claim 11, wherein the handshake method establishes a secure communication link between the Lv and the Fv.

18. The method of claim 17, wherein the handshake method confirms control function of the Fv based on communications from the Lv.

19. The method of claim 18, wherein the handshake method confirms the control functions based on a machine learning model that analyzes a scene of the Lv.

20. The method of claim 11, further comprising controlling a notification device of at least one of the Lv and the Fv to indicate the ODA service.
